(19) United States
(12) Patent Application Publication
(10) Pub. No.: US 2026/0241947 A1
(43) Pub. Date: Aug. 20, 2026

(54) VEHICLE CAPABLE OF AN EMERGENCY ACCELERATION STOP, AN EMERGENCY ACCELERATION STOP CONTROL METHOD, AND A STORAGE MEDIUM

(71) Applicants: HYUNDAI MOTOR COMPANY, Seoul (KR); KIA CORPORATION, Seoul (KR)

(72) Inventor: Yong Hyun Kim, Hwaseong-si (KR)

(73) Assignees: HYUNDAI MOTOR COMPANY, Seoul (KR); KIA CORPORATION, Seoul (KR)

(21) Appl. No.: 19/258,529

(22) Filed: Jul. 2, 2025

(30) Foreign Application Priority Data
Feb. 14, 2025 (KR) 10-2025-0019119

(51) Int. Cl. B60W 50/10; B60W 30/18; B60W 50/00; B60W 50/08; B60W 50/14

(52) U.S. Cl. CPC B60W 50/10; B60W 30/18009; B60W 50/087; B60W 50/14; B60W 2050/0071; B60W 2510/18; B60W 2520/10; B60W 2540/10; B60W 2710/305; B60W 2720/106

(57) ABSTRACT

A vehicle capable of an emergency acceleration stop includes a start input receiver configured to receive an input for starting the vehicle, a brake input receiver configured to receive an input for braking the vehicle, an acceleration input receiver configured to receive an input for accelerating the vehicle, an acceleration cutoff input receiver configured to receive an input for cutting off acceleration of the vehicle, and a controller configured to control acceleration cutoff of the vehicle, based on the input of the acceleration cutoff input receiver.

### CROSS-REFERENCE TO RELATED APPLICATION(S)

This application claims priority to Korean Patent Application No. 10-2025-0019119, filed on Feb. 14, 2025 in the Korean Intellectual Property Office, the disclosure of which is incorporated herein by reference in its entirety.

### BACKGROUND

### Technical Field

The present disclosure relates to a vehicle capable of an emergency acceleration stop, an emergency acceleration stop control method, and a storage medium.

### Description of Related Art

As aging of the population accelerates, traffic accidents involving elderly drivers have increased, emerging as a significant social issue. In response, major countries have implemented policies to strengthen physical and aptitude tests for elderly drivers or impose restrictions on their driver's licenses.

As people age, their physical structure and sensory-cognitive abilities may decline, leading to reduced judgment, decreased concentration, and slower reaction times. Consequently, elderly drivers may be at a higher risk of accidents. In particular, elderly drivers may unknowingly develop neurological disorders such as dementia, Parkinson's disease, or suffer strokes, which can significantly increase the fatality rate in accidents. For example, traffic accidents involving elderly drivers may often occur due to operational errors, such as pressing an accelerator pedal instead of a brake pedal in critical situations. In addition, elderly drivers may momentarily lose their sense of direction, driving onto sidewalks instead of roads or even going the wrong way on streets.

In automatic transmission vehicles, the absence of a clutch pedal may result in a brake pedal being positioned next to an accelerator pedal. This setup may lead to operational mistakes not only among inexperienced or elderly drivers but also among skilled drivers in emergency braking situations. Such errors may include pressing both pedals simultaneously or mistaking an accelerator for a brake pedal. As a result, instead of sudden braking, the vehicle may accelerate abruptly, exacerbating both property damage and personal injuries in accidents.

### SUMMARY

A vehicle capable of emergency acceleration stop, an emergency acceleration stop control method, and a storage medium according to an example embodiment of the present disclosure may stably prevent an accident caused by unintended acceleration by a driver (for example, acceleration resulting from confusion between an acceleration input receiver and a brake input receiver), substantially regardless of a driving skill level (and/or ability to respond to situations) of the driver.

According to an aspect of the present disclosure, there is provided a vehicle capable of an emergency acceleration stop, the vehicle including a start input receiver configured to receive an input for starting the vehicle, a brake input receiver configured to receive an input for braking the vehicle, an acceleration input receiver configured to receive an input for accelerating the vehicle, an acceleration cutoff input receiver configured to receive an input for cutting off acceleration of the vehicle, and a controller configured to control acceleration cutoff of the vehicle, based on the input of the acceleration cutoff input receiver.

For example, the controller may be configured to selectively control acceleration cutoff of the vehicle, according to whether an input pattern of the acceleration cutoff input receiver satisfies a predetermined condition.

For example, the vehicle may further include a steering input receiver configured to receive an input for steering the vehicle. The acceleration cutoff input receiver may include a paddle shift (or shifter) disposed on the steering input receiver.

For example, the paddle shift may be a plurality of paddle shifts respectively disposed on a first side and a second side of the steering input receiver. The predetermined condition may include a first condition in which the acceleration cutoff input receiver continuously receives an input for a predetermined period of time, and a second condition in which the plurality of paddle shifts receive an input together.

For example, the controller may be configured to receive an input and determine, based on the received input, whether to activate acceleration cutoff control of the vehicle based on an input of the paddle shift.

For example, the controller may be configured to control output of a notification signal when the input pattern of the acceleration cutoff input receiver satisfies the predetermined condition, and to control acceleration cutoff of the vehicle when the input pattern of the acceleration cutoff input receiver satisfies the predetermined condition after output of the notification signal.

For example, the controller may be configured to deactivate acceleration cutoff control of the vehicle based on the input of the acceleration cutoff input receiver, when the input pattern of the acceleration cutoff input receiver satisfies the predetermined condition, and a speed of the vehicle is lower than a reference speed, and activate acceleration cutoff control of the vehicle based on the input of the acceleration cutoff input receiver, when the input pattern of the acceleration cutoff input receiver satisfies the predetermined condition, and the speed of the vehicle is higher than or equal to the reference speed.

For example, the controller may be configured to control acceleration of the vehicle, based on the input of the acceleration input receiver, and to control acceleration cutoff of the vehicle, based on the input of the acceleration cutoff input receiver, and wherein when the controller receives the input of the acceleration input receiver and the input of the acceleration cutoff receiver at a same time, the controller controls acceleration cutoff of the vehicle.

For example, the controller may include a transmission controller configured to control a transmission of the vehicle. The controller may be configured to control acceleration cutoff of the vehicle by controlling the transmission of the vehicle using the transmission controller, based on the input of the acceleration cutoff input receiver.

For example, the controller may include a battery management controller configured to control management of a battery of the vehicle. The controller may be configured to control acceleration cutoff of the vehicle by controlling a relay of the battery or a fuse of the battery using the battery management controller, based on the input of the acceleration cutoff input receiver.

For example, the controller may include an oil pump controller configured to control an oil pump of the vehicle. The controller may be configured to control acceleration cutoff of the vehicle by controlling hydraulic pressure of the oil pump using the oil pump controller, based on the input of the acceleration cutoff input receiver.

For example, the controller may include at least one of a battery management controller configured to control management of a battery of the vehicle, or an oil pump controller configured to control an oil pump of the vehicle. The controller may be configured to control acceleration cutoff of the vehicle using at least one of the battery management controller or the oil pump controller in a software-based manner, based on the input of the acceleration cutoff input receiver, and control acceleration cutoff of the vehicle in a hardware-based manner by cutting off power supplied to at least one of the battery management controller or the oil pump controller, based on the input of the acceleration cutoff input receiver, after controlling acceleration cutoff in the software-based manner.

For example, the controller may include at least one of a battery management controller configured to control management of a battery of the vehicle, or an oil pump controller configured to control an oil pump of the vehicle. The controller may be configured to control acceleration cutoff of the vehicle by cutting off power supplied to at least one of the battery management controller or the oil pump controller, based on the input of the acceleration cutoff input receiver.

According to another aspect of the present disclosure, there is provided an emergency acceleration stop control method including a normal operation of controlling starting of a vehicle according to an input received by a start input receiver, controlling acceleration of the vehicle according to an input received by an acceleration input receiver, and controlling braking of the vehicle according to an input received by a brake input receiver, and an emergency stop operation of controlling acceleration cutoff of the vehicle, based on an input of an acceleration cutoff input receiver.

For example, the emergency stop operation may include selectively controlling output of a notification signal, according to whether an input pattern of the acceleration cutoff input receiver satisfies a predetermined condition, and controlling acceleration cutoff of the vehicle when the input pattern of the acceleration cutoff input receiver satisfies the predetermined condition after output of the notification signal.

For example, the normal operation may include receiving an input and determining, based on the received input, whether to activate the emergency stop operation. The emergency stop operation may be deactivated, when an input pattern of the acceleration cutoff input receiver satisfies a predetermined condition, and a speed of the vehicle is lower than a reference speed, and may be activated, when the input pattern of the acceleration cutoff input receiver satisfies the predetermined condition, and the speed of the vehicle is higher than or equal to the reference speed.

For example, the emergency stop operation may include controlling acceleration cutoff of the vehicle, based on the input of the acceleration cutoff input receiver, and when the input of the acceleration receiver and the input of the acceleration cutoff input receiver are received at a same time, the emergency stop operation is performed.

For example, the emergency stop operation may include controlling at least one of a transmission controller configured to control a transmission of the vehicle, a battery management controller configured to control management of a battery of the vehicle, or an oil pump controller configured to control an oil pump of the vehicle, based on the input of the acceleration cutoff input receiver.

For example, the emergency stop operation may include controlling cutoff of power supplied to at least one of a battery management controller configured to control management of a battery of the vehicle, or an oil pump controller configured to control an oil pump of the vehicle, based on the input of the acceleration cutoff input receiver.

According to another aspect of the present disclosure, there is provided a storage medium having recorded thereon one or more programs, including instructions for executing the emergency acceleration stop control method.

### BRIEF DESCRIPTION OF DRAWINGS

The above and other aspects, features, and advantages of the present disclosure should be more clearly understood from the following detailed description, taken in conjunction with the accompanying drawings.

FIG. 1 is a diagram illustrating an internal space of a vehicle capable of an emergency acceleration stop according to an example embodiment of the present disclosure.

FIG. 2 is a block diagram illustrating a controller of a vehicle capable of an emergency acceleration stop according to an example embodiment of the present disclosure.

FIG. 3 is a block diagram illustrating hardware-based acceleration cutoff control of a vehicle capable of an emergency acceleration stop and an emergency acceleration stop control method according to an example embodiment of the present disclosure.

FIG. 4 is a block diagram illustrating software-based acceleration cutoff control of a vehicle capable of an emergency acceleration stop and an emergency acceleration stop control method according to an example embodiment of the present disclosure.

FIG. 5 is a flowchart illustrating an emergency acceleration stop control method according to an example embodiment of the present disclosure;

FIG. 6 is a flowchart illustrating a process of processing an acceleration cutoff input by a vehicle capable of emergency acceleration stop and an emergency acceleration stop control method according to an example embodiment of the present disclosure.

FIG. 7 is a flowchart illustrating a process of controlling both software-based acceleration cutoff and hardware-based acceleration cutoff by a vehicle capable of an emergency acceleration stop and an emergency acceleration stop control method according to an example embodiment of the present disclosure.

### DETAILED DESCRIPTION

Various modifications may be made to the example embodiments. The example embodiments are not construed as being limited to the disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It should be further understood that the terms “comprises”, “has”, “includes” and/or “comprising,” when used in this code, specify the presence of stated features, integers, operations, operations, elements, components or a combination thereof, but do not preclude the presence or addition of one or more other features, integers, operations, operations, elements, components, and/or groups thereof.

Unless otherwise defined herein, all terms used herein including technical or scientific terms have the same meanings as those understood by one having ordinary skill in the art. Terms defined in dictionaries generally used should be construed to have meanings matching contextual meanings in the related art and are not to be construed as having an ideal or excessively formal meaning, unless otherwise defined herein.

As used herein, a vehicle (including an electric vehicle) refers to various vehicles transporting a transported object such as a person, animal, or object from a starting point to a destination. Such vehicles are not limited to vehicles travelling on roads or tracks.

Hereinafter, example embodiments of the present disclosure are described in more detail with reference to the accompanying drawings.

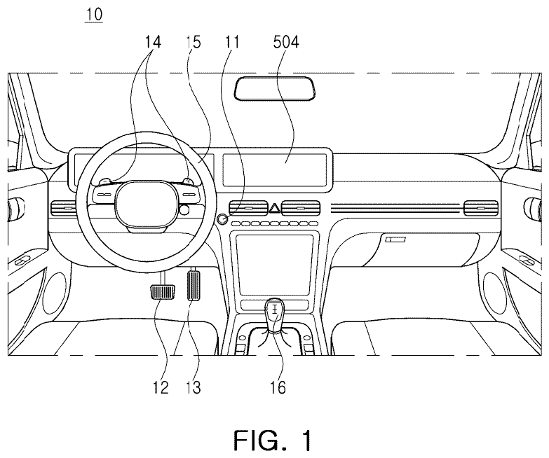

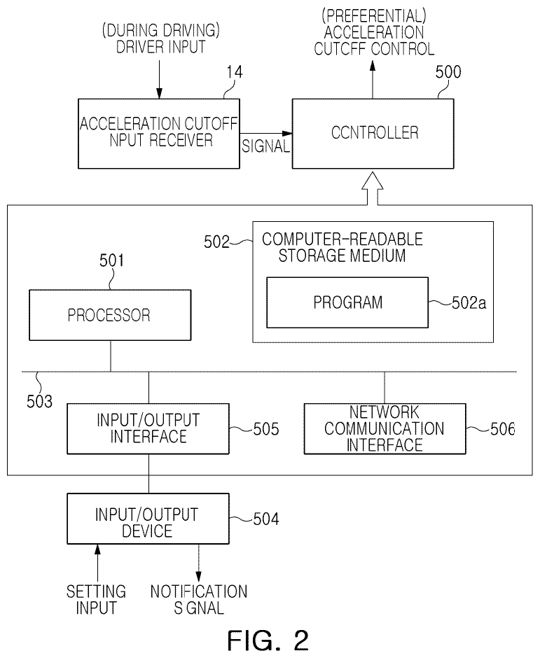

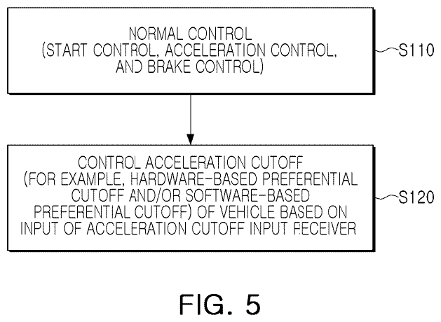

Referring to FIGS. 1 and 2, a vehicle capable of an emergency acceleration stop 10 (hereinafter the vehicle 10) according to an example embodiment of the present disclosure may include a start input receiver 11 for receiving an input for starting the vehicle 10, a brake input receiver 12 for receiving an input for braking the vehicle 10 (e.g., a brake pedal), and an acceleration input receiver 13 for receiving an input for accelerating the vehicle 10 (e.g., an acceleration pedal). Referring to FIGS. 2 and 5, an emergency acceleration stop control method according to an example embodiment of the present disclosure may include a normal operation (S110) of controlling, by the start input receiver 11, starting of the vehicle 10 based on the received input, controlling, by the acceleration input receiver 13, acceleration of the vehicle 10, based on the received input, and controlling, by the brake input receiver 12, braking of the vehicle 10, based on the received input.

FIG. 1 illustrates that the start input receiver 11 has a button structure receiving a press input of a driver (i.e., configured to be pressed by the driver). Depending on a design thereof, the start input receiver 11 may be implemented in a structure different from the button structure, such as a structure receiving an input of a key. For example, the key may be implemented as at least one of a physical key inserted into the start input receiver 11, a smart key close to the start input receiver 11 to communicate with the start input receiver 11 (for example, wired communication or short-range wireless communication), or a digital key included in a terminal of the driver to communicate with the start input receiver 11. For example, the start input receiver 11 may be implemented to receive a start input signal from the smart key or digital key through communication (for example, implemented as an input/output device 504 or a network communication interface 506 of the controller 500).

FIG. 1 illustrates that the brake input receiver 12 and the acceleration input receiver 13 have a pedal structure receiving a press input of the driver (i.e., configured to be pressed by a foot of the driver). However, the present disclosure is not limited thereto, and may be implemented as one of various designs in which there is a possibility of confusion between the brake input receiver 12 and the acceleration input receiver 13 during driving.

Some experienced drivers may be less likely to be confused between the brake input receiver 12 and the acceleration input receiver 13. Even in an unexpectedly urgent situation, when a driver mistakenly inputs a brake input into the acceleration input receiver 13 (i.e., mistakenly presses the accelerator instead of the brake), the driver may rapidly switch the input to the brake input receiver 12 or turn off ignition of the vehicle 10 using the ignition input receiver 11. However, a driving skill level (and/or ability to respond to situations) of each driver may vary greatly.

For example, when mistakenly inputting a brake input into the acceleration input receiver 13 in an unexpected urgent situation, many drivers may find it difficult to rapidly switch the input to the brake input receiver 12, and may also find it difficult to turn off ignition of the vehicle 10 using the start input receiver 11, which may lead to an accident involving the vehicle 10. As a driving skill level (and/or ability to respond to situations) of a driver decreases, the driver may be more likely to mistakenly input a brake input into the acceleration input receiver 13, which may raise the possibility of an accident involving the vehicle 10.

Referring to FIGS. 1 and 2, the vehicle 10 according to an example embodiment of the present disclosure may include an acceleration cutoff input receiver 14 for receiving an input for cutting off acceleration of the vehicle 10, and a controller 500 for controlling acceleration cutoff of the vehicle 10, based on an input of the acceleration cutoff input receiver 14. Referring to FIGS. 2 and 5, the emergency acceleration stop control method according to an example embodiment of the present disclosure may include an emergency stop operation (S120) of controlling acceleration cutoff of the vehicle 10, based on the input of the acceleration cutoff input receiver 14.

Accordingly, even when a driver mistakenly inputs a brake input into the acceleration input receiver 13 in an unexpected urgent situation, the driver may activate the acceleration cutoff input receiver 14 to emergency stop the vehicle 10. Operating the acceleration cutoff input receiver 14 during driving may not require a driving skill level (and/or ability to respond to situations) of the driver, thereby stably preventing an accident involving the vehicle 10 caused by unintended acceleration (for example, acceleration resulting from confusion between the acceleration input receiver 13 and the brake input receiver 12) of the driver, substantially regardless of the driving skill level (and/or ability to respond to situations) of the driver.

The acceleration cutoff input receiver 14 may be implemented separately from the start input receiver 11, the brake input receiver 12, and the acceleration input receiver 13. For example, when a driver mistakenly inputs a brake input into the acceleration input receiver 13 in an unexpected urgent situation, it may indicate that the driver has difficulty concentrating on a pedal structure (or that an additional input using a foot is difficult). Accordingly, the acceleration cutoff input receiver 14 may be implemented separately from the pedal structures, such as the brake input receiver 12 and the acceleration input receiver 13, (for example, implemented to allow the driver to input an additional input using a body part other than the foot), thereby reducing the concentration required for the driver to operate the acceleration cutoff input receiver 14.

For example, the vehicle 10 may further include a steering input receiver 15 (e.g., a steering wheel) for receiving an input for steering the vehicle 10, and the acceleration cutoff input receiver 14 may include a paddle shift or shifter disposed on the steering input receiver 15. The paddle shift may be implemented separately from the pedal structures (for example, implemented to allow the driver to input an additional input using a hand).

In addition, the paddle shift of the acceleration cutoff input receiver 14 may be efficiently operated by the driver while the driver keeps eyes on the road and operating the steering input receiver 15 to avoid obstacles, thereby further reducing the concentration required for the driver to operate the acceleration cutoff input receiver 14, thereby more stably preventing an accident caused by confusion between the acceleration input receiver 13 and the brake input receiver 12.

For example, the paddle shift of the acceleration cutoff input receiver 14 may also receive an input for another operation (for example, vehicle transmission control) rather than acceleration cutoff. The driver may use the paddle shift for the other operation under normal driving conditions, and thus the driver may easily get used to the paddle shift, enabling a stable vehicle emergency stop using the familiar paddle shift even in an unexpected urgent situation.

For example, the paddle shift of the acceleration cutoff input receiver 14 may be a plurality of paddle shifts or shifters disposed on both sides, i.e., a first side and a second side, of the steering input receiver 15, and the driver may operate the paddle shifts using both hands. For example, the paddle shift may be implemented as a handle-attached type paddle shift, and the driver may operate both the steering input receiver 15 and the acceleration cutoff input receiver 14 simultaneously, but the present disclosure is not limited thereto. The paddle shift may also be implemented as a fixed type paddle shift, depending on a design thereof.

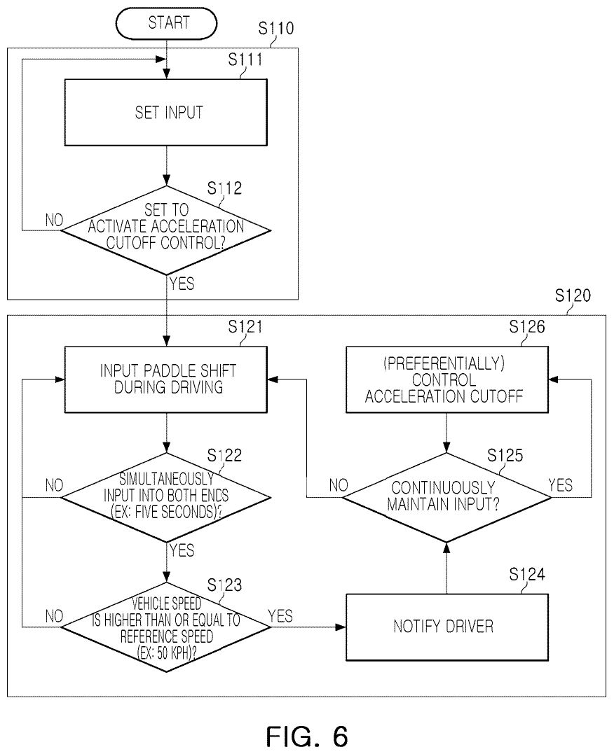

Referring to FIGS. 1 and 6, in the emergency stop operation (S120), the controller 500 may selectively control acceleration cutoff of the vehicle 10 based on whether an input pattern (S121) of the acceleration cutoff input receiver 14 (for example, the paddle shift) may satisfy a predetermined condition. Accordingly, even when the acceleration cutoff input receiver 14 (for example, the paddle shift) is implemented to further receive an input for another operation (for example, vehicle transmission control) rather than acceleration cutoff, the acceleration cutoff input receiver 14 (for example, the paddle shift) may receive the input for the other operation and the input for acceleration cutoff separately from each other.

For example, the predetermined condition may include a first condition (for example, 5 seconds) in which the acceleration cutoff input receiver 14 (for example, the paddle shift) continuously receives an input for a predetermined period of time (for example, 5 seconds), and a second condition (S122) in which the plurality of paddle shifts (disposed on both sides of the steering input receiver 15) may receive an input together. Accordingly, the possibility that an acceleration cutoff input pattern, unintentionally input by a driver in a normal situation, satisfies the predetermined condition, may be reduced. In other words, unnecessary execution of acceleration cutoff control in a normal situation may be prevented.

In the normal operation (S110), the controller 500 may receive an input (S111), and may determine, based on the received input, whether to activate acceleration cutoff control of vehicle 10 based on an input of the acceleration cutoff input receiver 14 (for example, the paddle shift) (S112).

For example, the driver may select whether the acceleration cutoff input receiver 14 (for example, the paddle shift) receives an acceleration cutoff control input according to a driving skill level (and/or ability to respond to situations) of the driver. The driver may input the selection into a selection interface (for example, a touchpad or button) of the input/output device 504 of the controller 500, to determine whether to activate acceleration cutoff control. Accordingly, unnecessary execution of acceleration cutoff control in a normal situation may be prevented.

When the input pattern (S121) of the acceleration cutoff input receiver 14 (for example, the paddle shift) satisfies the predetermined condition (for example, the first and second conditions), the controller 500 may control output of a notification signal (S124). After output of the notification signal, when the input pattern (S121) of the acceleration cutoff input receiver satisfies the predetermined condition (S125), the controller 500 may control acceleration cutoff of the vehicle 10 (S126).

For example, the input/output device 504 (for example, AVN (audio, video, navigation) or a cluster) of the controller 500 may implement the notification signal as a visual and/or auditory output. The driver may check the notification signal, maintain operation of the acceleration cutoff input receiver 14 (for example, the paddle shift) in an emergency stop situation, and stop operation of the acceleration cutoff input receiver 14 (for example, the paddle shift) in a normal situation (for example, when an acceleration cutoff input pattern is unintentionally input and satisfies the predetermined condition). Accordingly, unnecessary execution of acceleration cutoff control in a normal situation may be prevented.

In the emergency stop operation S120, when the input pattern (S121) of the acceleration cutoff input receiver 14 (for example, the paddle shift) satisfies the predetermined condition (for example, the first and second conditions) and a speed of the vehicle 10 is lower than a reference speed (for example, 50 kph) (No at S123), the controller 500 may deactivate acceleration cutoff control of the vehicle 10 based on the input of the acceleration cutoff input receiver (for example, the paddle shift). When the input pattern (S121) of the acceleration cutoff input receiver satisfies the predetermined condition (for example, the first and second conditions) and the speed of the vehicle 10 is higher than or equal to the reference speed (for example, 50 kph) (Yes at S123), the controller 500 may activate acceleration cutoff control of the vehicle 10 based on the input of the acceleration cutoff input receiver (for example, the paddle shift). For example, the controller 500 may periodically receive a speed value from a speed sensor of vehicle 10.

For example, when the driver is confused between the acceleration input receiver 13 and the brake input receiver 12, the vehicle speed may be likely to be higher than or equal to the reference speed (for example, 50 kph). When the vehicle speed is lower than the reference speed (for example, 50 kph), the driver may be likely to input an input into the acceleration cutoff input receiver (for example, the paddle shift) for another operation (for example, vehicle transmission control) rather than for emergency stop. Accordingly, whether to activate acceleration cutoff control may be determined according to the vehicle speed of the vehicle 10, thereby preventing unnecessary execution of acceleration cutoff control in a normal situation.

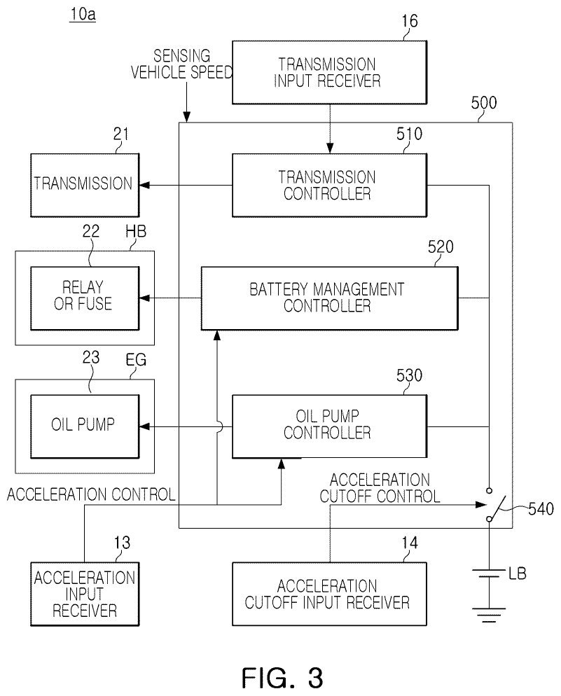

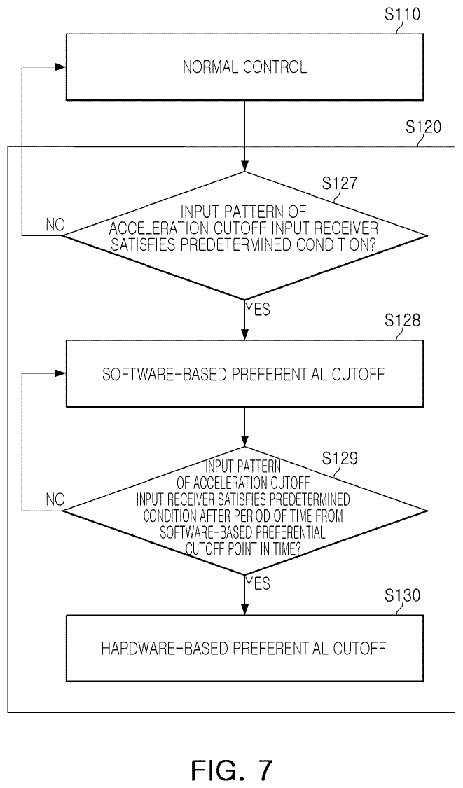

Referring to FIGS. 3, 4, and 7, the controller 500 may include at least one of a transmission controller 510, a battery management controller 520, an oil pump controller 530, or a power supply switch 540. For example, the controller 500 may be implemented as an electronic control unit (ECU), but the present disclosure is not limited thereto.

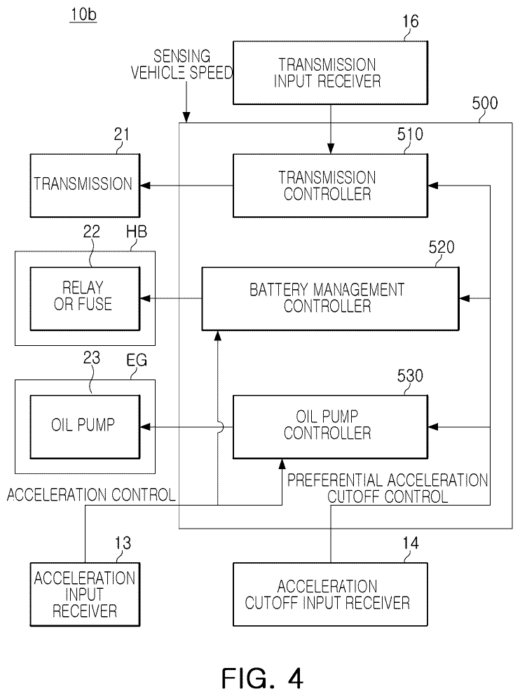

For example, when vehicles 10a and 10b of FIGS. 3 and 4 are electric vehicles, the vehicles 10a and 10b may not include the oil pump controller 530 and an engine EG. For example, when the vehicles 10a and 10b are internal combustion engine vehicles, the vehicles 10a and 10b may not include the battery management controller 520 and a battery HB. For example, when the vehicles 10a and 10b are plug-in hybrid vehicles, the vehicles 10a and 10b may include the oil pump controller 530, the engine EG, the battery management controller 520, and the battery HB.

In the emergency stop operation S120, the controller 500 may control acceleration of the vehicles 10a and 10b, based on an input of the acceleration input receiver 13, and may control acceleration cutoff of the vehicles 10a and 10b more preferentially than acceleration control of the vehicles 10a and 10b, based on an input of the acceleration cutoff input receiver 14. Accordingly, the controller 500 may stably control emergency stop operations of the vehicles 10a and 10b based on the input of the acceleration cutoff input receiver 14. In other words, when the controller receives the input of the acceleration input receiver 13 (i.e., the accelerator pedal being pressed) and the controller receives the input of the acceleration cutoff input receiver 14 (i.e., the paddle shift being pressed) at the same time while in the emergency stop operation S120, the controller 500 controls the acceleration cutoff of the vehicle 10 rather than acceleration of the vehicle 10. In this way, when a driver simultaneously presses the acceleration pedal and the paddle shift during the emergency stop operation S120, the controller 500 prioritizes the paddle shift to control acceleration cutoff in order to perform emergency stop operations.

For example, the controller 500 may include at least one of the battery management controller 520 or the oil pump controller 530. In the emergency stop operation S120, the controller 500 may control acceleration cutoff of the vehicle 10a by cutting off power LB supplied to at least one of the battery management controller 520 or the oil pump controller 530, based on the input of the acceleration cutoff input receiver 14. Accordingly, the controller 500 may stop control of the battery management controller 520 and the oil pump controller 530, regardless of acceleration control of the battery management controller 520 and the oil pump controller 530, and thus the controller 500 may control acceleration cutoff of the vehicle 10a more preferentially than acceleration control. Preferential control based on power supply cutoff may be defined as hardware-based control.

For example, the controller 500 may include the power supply switch 540, and may control whether the power supply switch 540 is turned on or off, thereby controlling whether to cut off the power LB supplied to at least one of the battery management controller 520, the oil pump controller 530, or the transmission controller 510. For example, the power LB may be implemented as a battery of a specific rated voltage (for example 5V or 12V).

The power supply switch 540 of the controller 500 may be independent of control of the transmission controller 510, the battery management controller 520, and the oil pump controller 530, and ON/OFF of the power supply switch 540 may be controlled, regardless of whether the driver operates the acceleration input receiver 13. Accordingly, the controller 500 may stably control the emergency stop operation of the vehicle 10a based on the input of the acceleration cutoff input receiver 14.

For example, the power supply switch 540 may be implemented as a switch performing cutoff control according to overcurrent, such as a fuse (for example, a pyro fuse), and the controller 500 may be implemented to form the overcurrent according to the input of the acceleration cutoff input receiver 14. For example, the power supply switch 540 may be implemented as a semiconductor transistor, and a voltage of a gate terminal of the semiconductor transistor may be determined according to the input of the acceleration cutoff input receiver 14, and whether to perform electrical connection between a drain terminal and a source terminal of the semiconductor transistor may be determined.

Depending on a design thereof, the above-described hardware-based control may be replaced with software-based control to be described below, or may be combined with the software-based control. For example, in the emergency stop operation S120, the controller 500 may control, based on the input of the acceleration cutoff input receiver 14 (S127), acceleration cutoff of the vehicles 10a and 10b in a software-based manner using at least one of the battery management controller 520 or the oil pump controller 530 (S128), and may control, based on the input of the acceleration cutoff input receiver 14 (S129), acceleration cutoff of the vehicles 10a and 10b in a hardware-based manner by cutting off power supplied to at least one of the battery management controller 520 or the oil pump controller 530 (S130), after controlling acceleration cutoff in the software-based manner.

For example, the controller 500 may include a transmission controller 510 controlling a transmission 21 of the vehicle 10b. In the emergency stop operation S120, the controller 500 may control the transmission 510 of the vehicle using the transmission controller 510, based on the input of the acceleration cutoff input receiver 14, thereby preferentially controlling acceleration cutoff of the vehicles 10a and 10b.

For example, the transmission controller 510 may be a transmission control unit (TCU), and may control the transmission 21 according to operation (or automatic transmission control) of a transmission input receiver 16 by the driver. The controller 500 may preferentially control the transmission controller 510, such that a gear of the vehicle 10b is forcibly in a neutral (N-stage) state by the input of the acceleration cutoff input receiver 14, regardless of current control of the transmission controller 510. In the neutral (N-stage) state, acceleration of the vehicle 10b may be preferentially cut off.

For example, the controller 500 may include the battery management controller 520 controlling management of the battery HB of the vehicle 10b. In the emergency stop operation S120, the controller 500 may control acceleration cutoff of the vehicle 10b by controlling a relay or fuse 22 of the battery HB using the battery management controller 520, based on the input of the acceleration cutoff input receiver 14.

For example, the battery management controller 520 may be a controller for a battery management system (BMS), and the battery HB may be a high-voltage battery. The battery HB may be electrically connected to a motor of the vehicle 10b, and a converter (inverter and/or rectifier) for switching between direct current and alternating current may be connected between the motor and the battery HB. The battery management controller 520 may control the battery HB to be discharged to the motor according to operation of the acceleration input receiver 13 by the driver, and may control the relay or fuse 22 to monitor a state (for example, voltage, current, or temperature) of the battery HB and protect the battery HB according to a monitoring result. The relay or fuse 22 may be electrically connected between the battery HB and the motor, and whether the battery HB is discharged may be determined according to whether the relay or the fuse 22 is opened.

The controller 500 may preferentially control the battery management controller 520, such that the relay or fuse 22 may be forcibly opened by the input of the acceleration cutoff input receiver 14, regardless of the current control of the battery management controller 520. Accordingly, acceleration of the vehicle 10b may be preferentially cut off.

For example, the controller 500 may include an oil pump controller 530 controlling an oil pump 23 of the engine EG of the vehicle 10b. In the emergency stop operation S120, the controller 500 may control hydraulic pressure of the oil pump 23 using the oil pump controller 530, based on the input of the acceleration cutoff input receiver 14, thereby controlling acceleration cutoff of the vehicle 10b.

For example, the oil pump controller 530 may be an oil pump unit (OPU), and the oil pump 23 may be an electric oil pump (EOP). The oil pump controller 530 may control the oil pump 23 according to operation of the acceleration input receiver 13 by the driver. The controller 500 may preferentially control the oil pump controller 530 to reduce output of the engine EG by the input of the acceleration cutoff input receiver 14, regardless of current control of the oil pump controller 530. Accordingly, acceleration of the vehicle 10b may be preferentially cut off.

Referring to FIG. 2, the controller 500 of the vehicle capable of emergency acceleration stop according to an example embodiment of the present disclosure may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing an emergency acceleration stop control method according to an example embodiment of the present disclosure. The communication bus 503 may interconnect various other components of the computing device 500, including the processor 501 and the computer-readable storage medium 502.

The processor 501 may cause the computing device 500 to operate according to an example embodiment described above. For example, the processor 501 may execute one or more programs stored in the computer-readable storage medium 502. The one or more programs may include one or more computer-executable instructions. When executed by the processor 501, the one or more computer-executable instructions may be configured to cause the computing device 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment of the present disclosure, the computer-readable storage medium 502 may be a memory (a volatile memory such as a random access memory, a non-volatile memory, or any suitable combination thereof), one or more magnetic disk storage devices, optical disk storage devices, flash memory devices, other types of storage media that are accessible by the computing device 500 and are capable of storing desired information, or any suitable combinations thereof.

The computing device 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), or long-term evolution (LTE), or another cellular network, and may be implemented as Ethernet, media-oriented systems transport (MOST), Flexray, controller area network (CAN), local interconnect network (LIN), Internet, Bluetooth, near field communication (NFC), Zigbee®, radio frequency (RF), or the like.

The input/output device 504 may be connected to other components of the computing device 500 through the input/output interface 505. The input/output device 504 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The input/output device 504 may be included in the computing device 500 as a component included in the computing device 500, or may be connected to the computing device 500 as a device, distinct from the computing device 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of an example embodiment of the present disclosure, or may be of the well-known kind and available to those having ordinary skill in the art. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While example embodiments of the present disclosure have been shown and described above, it should be apparent to those having ordinary skill in the art that modifications and variations could be made without departing from the scope of the present disclosure as defined by the appended claims.

What is claimed is:

1. A vehicle capable of an emergency acceleration stop, the vehicle comprising:
a start input receiver configured to receive an input for starting the vehicle;
a brake input receiver configured to receive an input for braking the vehicle;
an acceleration input receiver configured to receive an input for accelerating the vehicle;
an acceleration cutoff input receiver configured to receive an input for cutting off acceleration of the vehicle; and
a controller configured to control acceleration cutoff of the vehicle, based on the input of the acceleration cutoff input receiver.

2. The vehicle of claim 1, wherein the controller is configured to selectively control acceleration cutoff of the vehicle, based on whether an input pattern of the acceleration cutoff input receiver satisfies a predetermined condition.

3. The vehicle of claim 2, further comprising:
a steering input receiver configured to receive an input for steering the vehicle,
wherein the acceleration cutoff input receiver includes a paddle shift disposed on the steering input receiver.

4. The vehicle of claim 3, wherein
the paddle shift is a plurality of paddle shifts disposed on a first side and a second side of the steering input receiver, and
the predetermined condition includes a first condition in which the acceleration cutoff input receiver continuously receives an input for a predetermined period of time, and a second condition in which the plurality of paddle shifts receive an input together.

5. The vehicle of claim 3, wherein the controller is configured to receive an input and determine, based on the received input, whether to activate acceleration cutoff control of the vehicle based on an input of the paddle shift.

6. The vehicle of claim 2, wherein the controller is configured to control output of a notification signal when the input pattern of the acceleration cutoff input receiver satisfies the predetermined condition, and to control acceleration cutoff of the vehicle when the input pattern of the acceleration cutoff input receiver satisfies the predetermined condition after output of the notification signal.

7. The vehicle of claim 2, wherein the controller is configured to:
deactivate acceleration cutoff control of the vehicle based on the input of the acceleration cutoff input receiver, when the input pattern of the acceleration cutoff input receiver satisfies the predetermined condition, and a speed of the vehicle is lower than a reference speed; and
activate acceleration cutoff control of the vehicle based on the input of the acceleration cutoff input receiver, when the input pattern of the acceleration cutoff input receiver satisfies the predetermined condition, and the speed of the vehicle is higher than or equal to the reference speed.

8. The vehicle of claim 1, wherein the controller is configured to control acceleration of the vehicle, based on the input of the acceleration input receiver, and to control acceleration cutoff of the vehicle, based on the input of the acceleration cutoff input receiver, and wherein when the controller receives the input of the acceleration input receiver and the input of the acceleration cutoff receiver at a same time, the controller controls acceleration cutoff of the vehicle.

9. The vehicle of claim 8, wherein
the controller includes a transmission controller configured to control a transmission of the vehicle, and
the controller is configured to control acceleration cutoff of the vehicle by controlling the transmission of the vehicle using the transmission controller, based on the input of the acceleration cutoff input receiver.

10. The vehicle of claim 8, wherein
the controller includes a battery management controller configured to control management of a battery of the vehicle, and
the controller is configured to control acceleration cutoff of the vehicle by controlling a relay of the battery or a fuse of the battery using the battery management controller, based on the input of the acceleration cutoff input receiver.

11. The vehicle of claim 8, wherein
the controller includes an oil pump controller configured to control an oil pump of the vehicle, and
the controller is configured to control acceleration cutoff of the vehicle by controlling a hydraulic pressure of the oil pump using the oil pump controller, based on the input of the acceleration cutoff input receiver.

12. The vehicle of claim 8, wherein
the controller includes at least one of a battery management controller configured to control management of a battery of the vehicle, or an oil pump controller configured to control an oil pump of the vehicle, and
the controller is configured to:
control acceleration cutoff of the vehicle using at least one of the battery management controller or the oil pump controller in a software-based manner, based on the input of the acceleration cutoff input receiver; and
control acceleration cutoff of the vehicle in a hardware-based manner by cutting off power supplied to at least one of the battery management controller or the oil pump controller, based on the input of the acceleration cutoff input receiver, after controlling acceleration cutoff in the software-based manner.

13. The vehicle of claim 1, wherein
the controller includes at least one of a battery management controller configured to control management of a battery of the vehicle, or an oil pump controller configured to control an oil pump of the vehicle, and
the controller is configured to control acceleration cutoff of the vehicle by cutting off power supplied to at least one of the battery management controller or the oil pump controller, based on the input of the acceleration cutoff input receiver.

14. An emergency acceleration stop control method comprising:
a normal operation including controlling starting of a vehicle according to an input received by a start input receiver, controlling acceleration of the vehicle according to an input received by an acceleration input receiver, and controlling braking of the vehicle according to an input received by a brake input receiver; and
an emergency stop operation including controlling acceleration cutoff of the vehicle, based on an input of an acceleration cutoff input receiver.

15. The emergency acceleration stop control method of claim 14, wherein the emergency stop operation includes selectively controlling output of a notification signal, according to whether an input pattern of the acceleration cutoff input receiver satisfies a predetermined condition, and controlling acceleration cutoff of the vehicle when the input pattern of the acceleration cutoff input receiver satisfies the predetermined condition after output of the notification signal.

16. The emergency acceleration stop control method of claim 14, wherein
the normal operation includes receiving an input and determining, based on the received input, whether to activate the emergency stop operation, and
the emergency stop operation is deactivated, when an input pattern of the acceleration cutoff input receiver satisfies a predetermined condition, and a speed of the vehicle is lower than a reference speed, and is activated, when the input pattern of the acceleration cutoff input receiver satisfies the predetermined condition, and the speed of the vehicle is higher than or equal to the reference speed.

17. The emergency acceleration stop control method of claim 14, wherein the emergency stop operation includes controlling acceleration cutoff of the vehicle, based on the input of the acceleration cutoff input receiver and wherein when the input of the acceleration input receiver and the input of the acceleration cutoff input receiver are received at a same time, the emergency stop operation is performed.

18. The emergency acceleration stop control method of claim 17, wherein the emergency stop operation includes controlling at least one of a transmission controller configured to control a transmission of the vehicle, a battery management controller configured to control management of a battery of the vehicle, or an oil pump controller configured to control an oil pump of the vehicle, based on the input of the acceleration cutoff input receiver.

19. The emergency acceleration stop control method of claim 14, wherein the emergency stop operation includes controlling cutoff of power supplied to at least one of a battery management controller configured to control management of a battery of the vehicle, or an oil pump controller configured to control an oil pump of the vehicle, based on the input of the acceleration cutoff input receiver.

20. A storage medium recording one or more programs including instructions for executing the emergency acceleration stop control method of claim 14.
